(19) United States
(12) Patent Application Publication
(10) Pub. No.: US 2016/0233510 A1
(43) Pub. Date: Aug. 11, 2016

(54) ALL-SOLID STATE BATTERY, ELECTRODE FOR ALL-SOLID STATE BATTERY, AND METHOD OF MANUFACTURING THE SAME

(71) Applicant: HITACHI, LTD., Tokyo (JP)

(72) Inventors: Taigoh ONODERA, Tokyo (JP); Tadashi FUJIDERA, Tokyo (JP); Jun KAWAJI, Tokyo (JP)

(73) Assignee: HITACHI, LTD., Tokyo (JP)

(21) Appl. No.: 15/024,645

(22) PCT Filed: Nov. 8, 2013
(86) PCT No.: PCT/JP2013/080271

§ 371 Date: Mar. 24, 2016

(51) Int. Cl. H01M 4/62; H01M 10/0562; H01M 4/131; H01M 4/134; H01M 4/1391; H01M 4/38; H01M 4/66; H01M 10/0585; H01M 4/04; H01M 4/1395; H01M 10/0525; H01M 4/525

(52) U.S. Cl. CPC H01M 4/62; H01M 10/0525; H01M 10/0562; H01M 4/131; H01M 4/134; H01M 4/525; H01M 4/382; H01M 4/661; H01M 10/0585; H01M 4/0471; H01M 4/043; H01M 4/0404; H01M 4/1395; H01M 4/1391; H01M 2004/028

(57) ABSTRACT

Provided are an all-solid state battery with a better quality of contact among particles of an active material and with an enhanced discharge capacity; an electrode for an all-solid state battery; and a method of manufacturing the same. The all-solid state battery is manufactured through the steps of: causing a deliquescent solid electrolyte to deliquesce, the deliquescent solid electrolyte having ionic conductivity, electronic conductivity and a deliquescent property; preparing an electrode mixture by mixing the deliquescent solid electrolyte having deliquesced and an active material together; heat-treating and shaping the electrode mixture to produce an electrode; and bonding the thus-produced electrode and a solid electrolyte layer with the solid electrolyte layer interposed between the electrode and another electrode which are paired to serve as a positive electrode and a negative electrode.

### TECHNICAL FIELD

The present invention relates to an all-solid state battery, an electrode for an all-solid state battery, and a method of manufacturing the same.

### BACKGROUND ART

Portable personal computers, information communication apparatuses such as portable phone terminals, power storage systems for household use, hybrid vehicles, electric vehicles and the like, that use secondary batteries as power sources, have become in increasingly wide use in recent years. A lithium-ion secondary battery, which is a kind of secondary battery, is a battery having a higher energy density than does any other secondary battery, such as a nickel-hydrogen battery. Since, however, the lithium-ion secondary battery uses an inflammable organic solvent as a liquid electrolyte, the lithium-ion secondary battery needs to be additionally equipped with a safety device for preventing the lithium-ion secondary battery from possibly catching fire or rupturing due to overcurrent triggered by short circuit, or other cause. Furthermore, measures for preventing such a phenomenon likely restrict the selection of battery materials, and the design of a battery structure.

Against this background, development of all-solid state batteries using a solid electrolyte instead of the liquid electrolyte has been in progress. Since the all-solid state batteries include no inflammable organic solvent, an advantage of the all-solid state batteries is simplification of the safety device. Accordingly, the all-solid state batteries are considered as being superior in manufacturing costs and productivity. Moreover, since bonding structures each including a pair of electrodes, that is to say, a positive electrode and a negative electrode, as well as a solid electrolyte layer interposed between these electrodes, are easily placed one over another in series, the all-solid state batteries are expected as a technology which makes it possible to manufacture batteries having high stability, high capacity and high output.

With regard to the all-solid state battery, it has been known that contact resistance among particles of an active material for battery reaction and between the particles of the active material and particles of a solid electrolyte has a large influence on internal resistance of the battery. Particularly, a repeated series of charging and discharging causes a change in the volume of the active material, which decreases the qualities of contact between the active material and the solid electrolyte, as well as between the active material and a conducting agent, etc., resulting in an increase in the internal resistance, a decrease in the capacity, and the like. With this taken into consideration, a technology has been proposed for enhancing the quality of contact among the particles of the active material and the particles of the solid electrolyte, thereby inhibiting the increase in the internal resistance, and the like.

For example, Patent Literature 1 has disclosed a lithium secondary battery in which at least one of a positive electrode and a negative electrode includes particles of an active material each coated with a coating layer containing a conducting agent and a lithium-ion conductive inorganic solid electrolyte.

Meanwhile, Patent Literature 2 has disclosed a composite active material which includes an active material; and a coating layer formed on a surface of the active material, and containing a carbon material and an ion conductive oxide, and in which a concentration of carbon elements in the surface of the coating layer is 17.0 atm % or greater.

### CITATION LIST

### Patent Literature

Patent Literature 1: JP 2003-059492 A

Patent Literature 2: JP 2013-134825 A

### SUMMARY OF INVENTION

### Technical Problem

To increase the capacity of the all-solid state battery by decreasing contact resistance among the particles of the active material for the battery reaction and between the particles of the active material and the particles of the solid electrolyte, it seems necessary to enhance the quality of contact among the particles, and to arrange the particles in intimate contact with one another to narrow gaps among the particles as much as possible. However, the technologies respectively disclosed in Patent Literature 1 and Patent Literature 2 are far from satisfying the above-mentioned requirement since their use of the particles of the active material each coated with the solid electrolyte leave not a small number of particles of the active material in point contact with one another. Moreover, the two technologies have difficulty in achieving an enhancement in the quality of contact and an increase in energy density at the same time since the two technologies produce electrodes each still having a large number of gaps among the particles of the active material. Against this background, a problem to be solved by the present invention is to provide an all-solid state battery with a better quality of contact among particles of active material and with an improved discharge capacity; an electrode for an all-solid state battery; and a method of manufacturing the same.

### Solution to Problem

To solve the problems described above, the all-solid state battery according to the present invention includes: a pair of electrodes including a positive electrode and a negative electrode; and a solid electrolyte layer interposed between the positive electrode and the negative electrode, wherein at least one of the positive electrode and the negative electrode includes an electrode layer including a deliquescent solid electrolyte having ionic conductivity, electronic conductivity and a deliquescent property, and particles of an active material.

Additionally, the electrode for an all-solid state battery according to the present invention includes: a current collector; and an electrode layer formed on the current collector, and including a deliquescent solid electrolyte having ionic conductivity, electronic conductivity and a deliquescent property, and particles of an active material, wherein the electrode layer is formed by filling the deliquescent solid electrolyte among the particles of the active material, and the deliquescent solid electrolyte is an alkali metal metavanadate.

Moreover, a method of manufacturing an all-solid state battery according to the present invention includes the steps of: causing a deliquescent solid electrolyte to deliquesce, the deliquescent solid electrolyte having ionic conductivity, electronic conductivity and a deliquescent property; preparing an electrode mixture by mixing the deliquescent solid electrolyte having deliquesced and an active material together; heat-treating and shaping the electrode mixture to produce the electrode; and bonding the thus-produced electrode and a solid electrolyte layer with the solid electrolyte layer interposed between the electrode and another electrode which are paired to serve as a positive electrode and a negative electrode.

### Advantageous Effects of Invention

According to the present invention, it is possible to provide an all-solid state battery with a better quality of contact among particles of active material and with an improved discharge capacity; an electrode for an all-solid state battery; and a method of manufacturing the same.

### BRIEF DESCRIPTION OF DRAWINGS

FIG. 1 is a cross-sectional diagram schematically showing an example of a configuration of an all-solid state battery of an embodiment; and

FIG. 2 is a diagram showing a relationship between a content of deliquescent solid electrolyte in each all-solid state battery of the embodiment and its discharge capacity.

### DESCRIPTION OF EMBODIMENTS

Hereinafter, an all-solid state battery, an electrode for an all-solid state battery, and a method of manufacturing the same of an embodiment of the present invention will be described in detail.

The all-solid state battery of the embodiment is a solid-state battery of a bulk type in which: solid electrolyte is involved in transmission of ionic carriers between electrodes; and electrode layers forming the respective electrodes are made mainly from active material particles in an aggregate form. The all-solid state battery includes a pair of electrodes, that is to say, a positive electrode and a negative electrode; and a solid electrolyte layer interposed between the positive electrode and the negative electrode. At least either of the pair of electrodes has an electrode layer including active material and deliquescent solid electrolyte.

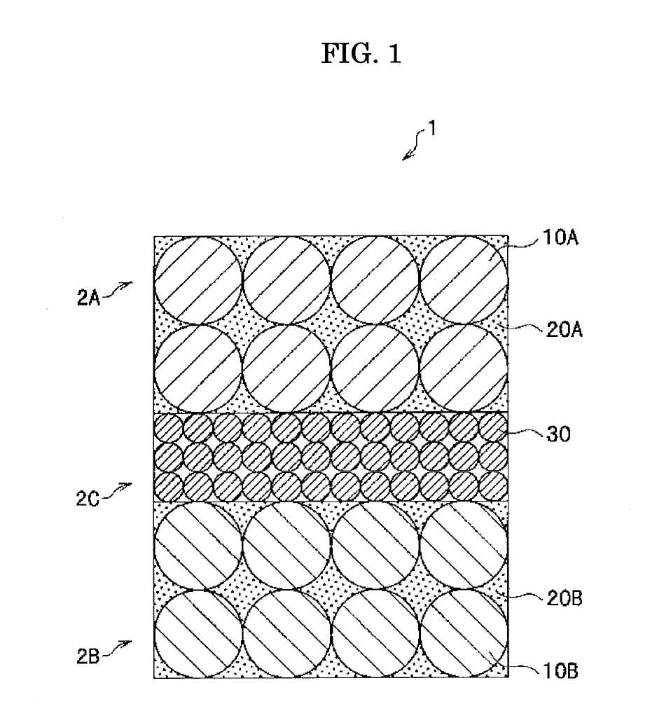

FIG. 1 is a cross-sectional diagram schematically showing an example of a configuration of the all-solid state battery of the embodiment.

This all-solid state battery is formed such that each of the positive electrode and the negative electrode has an electrode layer including active material and deliquescent solid electrolyte. As shown in FIG. 1, the all-solid state battery 1 includes a positive electrode layer 2A, a negative electrode layer 2B and a solid electrolyte layer 2C. The positive electrode layer 2A, the negative electrode layer 2B and the solid electrolyte layer 2C are stacked up in a way that the solid electrolyte layer 2C is interposed between the positive electrode layer 2A and the negative electrode layer 2B. Incidentally, the positive electrode layer 2A and the negative electrode layer 2B form the respective electrodes for the all-solid state battery by being connected to current collectors, substrates and the like (not illustrated).

In the all-solid state battery 1, the positive electrode layer 2A includes particles of positive electrode active material 10A and deliquescent solid electrolyte 20A; and the negative electrode layer 2B includes particles of negative electrode active material 10B and deliquescent solid electrolyte 20B. Incidentally, the solid electrolyte layer 2C is a layer including conventional solid electrolyte 30. In the electrode layer 2A made mainly from the particles of the positive electrode active material 10A in an aggregate form, the deliquescent solid electrolyte 20A is filled between the particles of the positive electrode active material 10A. In the electrode layer 2B made mainly from the particles of the negative electrode active material 10B in an aggregate form, the deliquescent solid electrolyte 20B is filled between the particles of the negative electrode active material 10B. In the all-solid state battery of the embodiment, the use, as cited in FIG. 1, of the deliquescent solid electrolyte in at least either of the pair of electrode layers makes the electrode layer hold the particles of the active material in close contact with one another, and enhances the quality of the contact among the particles of the active material using the deliquescent solid electrolyte.

The deliquescent solid electrolyte is solid electrolyte which has not only ionic conductivity for ions serving as carries for battery reaction, but also electronic conductivity, and which is deliquescent. It should be noted that the term “deliquescent” used in this description means having a property of becoming liquid as a result of absorbing water from the atmosphere at normal temperature (not lower than 5° C. but not higher than 35° C.). The use of the deliquescent solid electrolyte for manufacturing the electrode of the all-solid state battery makes it possible to form a matrix-like structure in which the solid electrolyte is densely filled in gaps among the particles of the active material constituting part of the electrode layer. The dense filling of the solid electrolyte in the gaps among the particles of the active material constituting part of the electrode layer allows the particles of the active material to come into contact with one another via the solid electrolyte having a wider area, but not merely into point contact.

The deliquescent solid electrolyte is further conductive to alkali metal ions serving as carriers for the battery reaction. To put it specifically, it is desirable that the degree of ionic conductivity of the deliquescent solid electrolyte be not less than 1×10⁻⁸ S/cm, and it is more preferable that the degree of ionic conductivity be not less than 1×10⁻⁶ S/cm. If the deliquescent solid electrolyte with a degree of ionic conductivity of not less than 1×10⁻⁸ S/cm fills the gaps among the particles of the active material, ionic conductivity among the particles of the active material, as well as ionic conductivity between the active material and the solid electrolyte can be significantly increased by the deliquescent solid electrolyte. This makes it possible for the all-solid state battery to satisfactorily decrease internal resistance, and to secure a higher discharge capacity. Incidentally, this degree of ionic conductivity is a value measured at 20° C.

The deliquescent solid electrolyte is further conductive to electrons generated by the battery reaction. To put it specifically, it is desirable that the degree of electronic conductivity of the deliquescent solid electrolyte be not less than 1×10⁻⁸ S/cm, and it is more preferable that the degree of ionic conductivity be not less than 1×10⁻⁶ S/cm. If the deliquescent solid electrolyte with a degree of electronic conductivity of not less than 1×10⁻⁸ S/cm fills the gaps among the particles of the active material, electronic conductivity among the particles of the active material, as well as electronic conductivity between the active material and the solid electrolyte can be significantly increased by the deliquescent solid electrolyte. This makes it possible for the all-solid state battery to satisfactorily decrease internal resistance, and to secure a higher discharge capacity. Incidentally, this degree of electronic conductivity is a value measured at 20° C.

While taking on mainly a crystalline form, the deliquescent solid electrolyte exists in the electrode layer. Immediately after its production, the electrode layer of the all-solid state battery is usually placed in an environment isolated from moisture. For this reason, the deliquescent solid electrolyte is deposited in mainly a crystalline form, but not in a deliquescent state, in the gaps among the particles of the active material. Thereby, the ionic conductivity and the electronic conductivity are preferably secured between the particles of the active material.

To put it concretely, citable examples of the deliquescent solid electrolyte include: solid electrolytes of alkali metal metavanadates such as lithium metavanadate (LiVO₃), sodium metavanadate (NaVO₃), and potassium metavanadate (KVO₃); a solid electrolyte of sodium ferrate (IV); and solid electrolytes of Li₂S—P₂S₅-based lithium sulfides. In other words, these types of solid electrolytes may be selectively used depending on ion species of the carriers in the all-solid state battery.

It is desirable that the content of the deliquescent solid electrolyte be not less than 5 mass % but not greater than 50 mass % of the total dry weight of the deliquescent solid electrolyte, non-deliquescent solid electrolyte and the active material in either the positive electrode or the negative electrode. When the content of the deliquescent solid electrolyte is 5 mass % or greater, the deliquescent solid electrolyte can be sufficiently filled in the gaps among the particles of the active material and in the gap between the active material and the solid electrolyte. Thereby, the ionic conductivity and the electronic conductivity can be preferably enhanced between the particles of the active material, and between the particles of the solid electrolyte. Accordingly, it is possible to obtain the all-solid state battery with lower internal resistance and higher discharge capacity. Meanwhile, if the content of the deliquescent solid electrolyte is 50 mass % or less, it is possible to keep the volume of the electrode layer small, and to obtain a preferable energy density per unit volume.

The active material for both the positive electrode layer and the negative electrode layer may be any one that is used for ordinary solid-state batteries. For example, an active material which occludes lithium ions may be used for the electrode if the all-solid state battery is a primary battery, and an active material which is electrochemically active enough for lithium ions to reversibly undergo insertion and dissociation may be used for the electrode if the all-solid state battery is a secondary battery.

If the carriers are lithium ions, examples of the positive electrode active material usable to be contained in the positive electrode layer include: lithium-transition metal compounds of an olivine type, such as manganese lithium phosphate (LiMnPO₄), iron lithium phosphate (LiFePO₄), and iron cobalt phosphate (LiCoPO₄); lithium-transition metal compounds of a layer type, such as lithium cobaltate (LiCoO₂), lithium nickelate (LiNiO₂), lithium manganese (III) dioxide (LiMnO₂), and ternary oxides expressed with LiNiₓCo_{y}Mn_{z}O₂ (in which 0≦x≦1, 0≦y≦1, 0≦z≦1, and x+y+z=1); lithium-transition metal compounds of a spinel type, such as lithium manganate (LiMn₂O₄); and lithium-transition metal compounds of polyanion type, such as vanadium lithium phosphate (Li₃V₂ (PO₄)₃). Meanwhile, if the carriers are sodium ions, examples of the usable positive electrode active material include sodium iron oxide (NaFeO₂), sodium cobaltate (NaCoO₂), sodium nickelate (NaNiO₂), sodium manganese (iii) dioxide (NaMnO₂), vanadium sodium phosphate (Na₃V₂(PO₄)₃), and vanadium sodium phosphate fluoride (Na₃V₂(PO₄)₂F₃). Additional examples of the usable positive electrode active material include: chalcogen compounds, such as copper Chevrel phase compound (Cu₂Mo₆S₈), iron sulfide (FeS, FeS₂), cobalt sulfide (CoS), nickel sulfide (NiS, Ni₃S₂), titanium sulfide (TiS₂), and molybdenum sulfide (MoS₂); metal oxides, such as TiO₂, V₂O₅, CuO, and MnO₂; and C₆Cu₂FeN₆.

If the carriers are lithium ions, examples of the negative electrode active material usable to be contained in the negative electrode layer include lithium-transition metal oxides such as lithium titanate (Li₄Ti₅O₁₂). Additional examples of the usable negative electrode active material include: alloys, such as TiSi and La₃Ni₂Sn₇; carbonaceous material, such as hard carbon, soft carbon, and graphite; and such metals as lithium, indium, aluminum, tin, and silicon, in the form of simple substance or alloy.

It is desirable that the particles of the active material be each shaped like a perfect sphere or elliptic sphere, and be of a monodisperse type. In addition, it is desirable that the active material be 0.1 to 50 μm in an average particle diameter. When the average particle diameter is 0.1 μm or greater, the active material in powder form will be rather easy to handle. Moreover, when the average particle diameter is 50 μm or less, the active material can have an adequate tap density, and the quality of contact among the particles of the active material in the electrode layer can be enhanced. The average particle diameter of the active material can be obtained by: observing an aggregate of particles of the active material with a scanning electron microscope or transmission electron microscope; and calculating an arithmetic mean of the particle diameters of a hundred particles randomly chosen. Incidentally, each particle diameter is measured as an average of a major-axis length and a minor-axis length of one particle using the electron microscope.

The electrode layer may contain the above-described deliquescent solid electrolyte together with other solid electrolyte (non-deliquescent solid electrolyte) which is generally used for ordinary solid-state batteries. A solid electrolyte to be used as the non-deliquescent solid electrolyte should be one that which is conductive to ions serving as carriers for battery reaction, and which does not deliquesce in the atmosphere at normal temperature (not lower than 5° C. but not higher than 35° C.). It is desirable that the non-deliquescent solid electrolyte be used in the form of mixture with the active material and the deliquescent solid electrolyte for the electrode layer. Thereby, the electrode layer is formed in which the deliquescent solid electrolyte is filled in gaps among particles of the active material, and in gaps among particles of the non-deliquescent solid electrolyte. When the non-deliquescent solid electrolyte is included in the electrode layer in this manner, the deliquescent solid electrode enables the quality of adhesion and contact to be improved not only among particles of the active material, but also among particles of the non-deliquescent solid electrolyte, as well as between the active material and the non-deliquescent solid electrolyte. The result of the improvement is higher ionic conductivity among particles of the active material through the solid electrolyte. Accordingly, it is possible to obtain the all-solid state battery having an increased discharge capacity.

To put it concretely, citable examples of the non-deliquescent solid electrolyte include: oxide-based solid electrolytes such as oxides in perovskite structure, oxides in NASICON structure, oxides in LISICON structure, and oxides in garnet structure; sulfide-based solid electrolytes; and β-alumina. Citable examples of the oxides in perovskite structure include: Li—La—Ti-based oxides in perovskite structure which are expressed with LiₐLa₁₋ₐTiO₃ or the like; Li—La—Ta-based oxides in perovskite structure which are expressed with Li_{b}La_{1-b}TaO₃ or the like; and Li—La—Nb-based oxides in perovskite structure which are expressed with LiₐLa₁₋ₐNbO₃ or the like (where 0<a<1, 0<b<1, and 0<c<1). Citable examples of the oxides in NACICON structure include oxides expressed with LiₘXₙYₒPₚO_{q} whose oikocryst is such crystal as (PO₄)₃, where X is at least one element selected from the group consisting of B, Al, Ga, In, C, Si, Ge, Sn, Sb and Se; Y is at least one element selected from the group consisting of Ti, Zr, Ge, In, Ga, Sn and Al; 0≦l≦1; and each of m, n, o, p and q is an arbitrary positive number. Citable examples of the oxides in LISICON structure include oxides expressed with Li₄XO₄—Li₃YO₄ (where X is at least one element selected from Si, Ge and Ti; and Y is at least one element selected from P, As and V). Citable examples of the oxides in garnet structure include Li—La—Zr-based oxides expressed with Li₇La₃Zr₂O₁₂ and the like. Citable examples of the sulfide-based solid electrolytes includes Li₂S—P₂S₅, Li₂S—SiS₂, Li_{3.25}P_{0.25}Ge_{0.76}S₄, Li₄₋ᵣGe₁₋ᵣPᵣS₄ (where 0≦r≦1), Li₇P₃S₁₁, and Li₂S—SiS₂—Li₃PO₄. The sulfide-based solid electrolytes may be either crystalline ones or amorphous ones. Incidentally, any of these non-deliquescent solid electrolytes may be one in which some of its constituent elements are partly replaced by other elements, or one which is different from the corresponding non-deliquescent solid electrolyte in terms of the composition ratio among the constituent elements, so long as its crystalline structure is identical. These non-deliquescent solid electrolytes may be used solely or in combination.

It is desirable that the degree of ionic conductivity of the non-deliquescent solid electrolyte be not less than 1×10⁻⁶ S/cm, and it is more preferable that the degree of ionic conductivity be not less than 1×10⁻⁴ S/cm. If the degree of ionic conductivity of the non-deliquescent solid electrolyte is 1×10⁻⁶ S/cm or greater, the combination use of the deliquescent solid electrolyte and the non-deliquescent solid electrolyte makes it possible to obtain the effect of enhancing the quality of contact among the particles using the deliquescent solid electrolyte, and concurrently makes it possible for the electrode layer to be with a higher ionic conductivity by the non-deliquescent solid electrolyte. This is because the deliquescent solid electrolyte tends to be poorer in crystallinity and lower in ionic conductivity than the non-deliquescent solid electrolyte. Incidentally, this degree of ionic conductivity is a value measured at 20° C.

The electrode layer may contain any conducting agent generally used for ordinary solid-state batteries. To put it concretely, citable examples of the conducting agent include: natural graphite particles; carbon black, such as acetylene black, Ketjen black, furnace black, thermal black, and channel black; carbon fiber; and particles of metal (such as nickel, copper, silver, gold, and platinum), and particles of alloy thereof. These conducting agents may be used solely or in combination.

The electrode layer may contain any binder generally used for ordinary solid-state batteries. To put it concretely, citable examples of the binder include polyvinylidene fluoride (PVDF), polytetrafluoroethylene (PTFE), polyhexafluoropropylene, styrene-butadiene rubber, acrylonitrile-butadiene rubber, ethylene-propylene copolymer, and styrene-ethylene-butadiene copolymer. The binder may be used together with a thickener, such as carboxymethylcellulose and xanthan gum. Incidentally, these binders and thickeners may be used solely or in combination.

The solid electrolyte layer is conductive to alkali metal ions serving as the carrier for battery reactions, and contains any solid electrolyte generally used for ordinary solid-state batteries. Examples of the solid electrolyte usable in the solid electrolyte layer include one or more species selected from the species for the non-deliquescent solid electrolyte. Incidentally, the solid electrolyte in the solid electrolyte layer may be identical with or different from that in the electrode layer. The all-solid state battery of the embodiment has the structure formed such that the gaps among the particles of the active material included in the electrode layer are densely filled with the deliquescent solid electrolyte. This structure is capable of: enhancing the quality of adhesion and contact between the solid electrolyte layer and the electrode layer; and decreasing surface resistance between the layers.

The all-solid state battery including the electrode layers and the solid electrolyte layer mentioned above may be configured such that the electrode layers, that is to say, the positive electrode layer and the negative electrode layer, are overlaid on base materials such as current collectors to work as the electrodes. The thickness of the electrode layers to be overlaid thereon may be set within an appropriate range depending on the configuration of the electrodes of the all-solid state battery. It is desirable that the thickness be set within a range, for example, not less than 0.1 μm but not greater than 1000 μm. The positive electrode current collector on which the positive electrode layer is overlaid may be a substrate, foil or the like of stainless steel, aluminum, iron, nickel, titanium, carbon or the like, for example. The negative electrode current collector on which the negative electrode layer is overlaid may be a substrate, foil or the like of stainless steel, copper, nickel, carbon or the like, for example.

Next, descriptions will be provided for the electrode for the all-solid state battery of the embodiment. The electrode for the all-solid state battery of the embodiment includes a current collector and an electrode layer formed thereon. The current collector included in the electrode for the all-solid state battery is made from the species of the positive electrode current collector and the negative electrode current collector used in the all-solid state battery described above. The current collector is shaped like a rectangle, circle or the like depending on the necessity. The electrode layer is formed on either or both sides of the current collector.

The electrode layer of the electrode for the all-solid state battery has the same configuration as that of the all-solid state battery described above, and contains the same active material and deliquescent solid electrolyte as used in the all-solid state battery. The electrode layer has a structure in which: the deliquescent solid electrolyte is filled among the particles of the active material; and the deliquescent solid electrolyte thereby makes the particles of the active material in close contact with one another. The such-structured electrode layer is bound to the current collector. Incidentally, the electrode layer may additionally contain the same non-deliquescent solid electrolyte, conducting agent, binder, etc. as used in the all-solid state battery described above.

The electrode for the all-solid state battery of the embodiment will be effectively used to manufacture the all-solid state battery with a lower internal resistance and a higher discharge capacity since the deliquescent solid electrolyte filled among the particles of the active material significantly enhances the electronic conductivity among the particles of the active material. In addition, since the electrode layer contains the deliquescent solid electrolyte, the manufacturing process under a condition that appropriate control of water content permits the deliquescent solid electrolyte to partly deliquesce makes it possible to produce the all-solid state battery having a better quality of adhesion and contact between the electrode layer and the solid electrolyte layer. In that case, if water remains in the all-solid state battery after its production, the battery will deteriorate. For this reason, it is desirable that a step of bonding the electrode layer and the solid electrolyte layer together be followed by heat treatment for drying the battery.

Next, descriptions will be provided for a method of manufacturing an all-solid state battery of the embodiment. The method of manufacturing an all-solid state battery of the embodiment includes, among other things, an electrode mixture preparing step of preparing an electrode mixture, an electrode forming step of forming an electrode by heat-treating and shaping the electrode mixture, and a bonding step of bonding the electrode and a solid electrolyte layer together.

In the electrode mixture preparing step, the electrode mixture preparation is accomplished by: causing the deliquescent solid electrolyte with ionic conductivity, electronic conductivity and a deliquescent property to deliquesce; and mixing the resultant deliquescent solid electrolyte and an active material together. The deliquescent solid electrolyte may be caused to deliquesce in the air at normal temperature. Under such an atmosphere, the deliquescent solid electrolyte is virtually completely dissolved in water through its reaction with moisture in the air, and the deliquescence is continued until being close to equilibrium with the atmosphere in which the step is being performed is almost reached. When the deliquescent solid electrolyte is caused to deliquesce in this manner, it is possible to obtain fluidity suitable to form the electrode layer in which the particles of the active material closely adhere together. Furthermore, when the deliquescent solid electrolyte is caused to deliquesce in this manner, the water content in the deliquescent solid electrolyte will not rise excessively, and the deliquescent solid electrolyte is less likely to turn into an aqueous solution. This makes it easy to form the structure in which the solid electrolyte is densely filled in the gaps among the particles of the active material included in the electrode layer. Accordingly, the quality of contact among the particles of the active material, that is to say, the ionic conductivity and the electronic conductivity, becomes better. Incidentally, no specific restriction is imposed on humidity of the atmosphere in which the deliquescence is performed. If, however, the humidity is too low, water may be added from the outside in an amount not enough for its vapor to come to equilibrium with the atmosphere in the step is being performed.

After the deliquescence of the deliquescent solid electrolyte, the active material is added to the dissolved deliquescent solid electrolyte, followed by being mixed to homogenize the components. Thereby, the electrode mixture is prepared. At this time, a non-deliquescent solid electrolyte and a conducting agent to be contained in the electrode layer may be added to the dissolved deliquescent solid electrolyte and the active material, followed by being mixed together. It is desirable that the dry weight of the deliquescent solid electrolyte to be mixed be not less than 5 parts by mass but not greater than 50 parts by mass with respect to the total dry weight of the deliquescent solid electrolyte, the non-deliquescent solid electrolyte, and the active material. The mixture of the deliquescent solid electrolyte in such an amount makes it possible to manufacture the all-solid state battery with a lower internal resistance, a better energy density per unit volume and a higher discharge capacity. Furthermore, a binder may also be added in combination with a solvent. Examples of the solvent usable according to the type of the solid electrolyte and the binder include water, N-methylpyrrolidone, N,N-dimethylformamide, N,N-dimethylacetamide, methanol, ethanol, propanol, ethylene glycol, glycerin, dimethylsulfoxide, and tetrahydrofuran. However, neither the binder nor the solvent has to be added because the non-deliquescent solid electrolyte having deliquesced is capable of binding particles together. Mixing to prepare the electrode mixture may be accomplished by using mixing means, such as a homomixer, disperse mixer, planetary mixer, revolving/rotating mixer, or the like, suitable for mixing high-viscous materials.

In the electrode forming step, the electrode mixture prepared as mentioned above is heat-treated, and is thereafter formed into the electrode layer containing the electrode mixture to produce the electrode. The heat treatment may be accomplished in an atmosphere of active gas such as air, or in an atmosphere of an inert gas such as a nitrogen gas and an argon gas. Furthermore, one species of gas may be used solely, or more than one species of gas may be used in combination. The heat treatment of the electrode mixture evaporates water dissolving the non-deliquescent solid electrolyte, and thereby causes the crystals of the non-deliquescent solid electrolyte to separate out around the particles of the active material. Thereby, it is possible to form a matrix-like structure in which the highly-dense solid electrolyte is filled in the gaps among the particles of the active material. This enhances the quality of contact among the particles of the active material using the solid electrolyte, that is to say, the ionic conductivity and the electronic conductivity.

The heating temperature for the heat treatment may be set appropriately depending on the composition of the electrode mixture. It is desirable that the heating temperature be not less than 15° C. but not greater than 650° C., and it is more desirable that the heating temperature be not less than 100° C. but not greater than 300° C. A heating temperature of 15° C. or greater makes it possible to preferably evaporate and remove water from the deliquescent solid electrolyte for drying in the air. Meanwhile, a heating temperature of 650° C. or less makes it possible to avoid solid phase reaction between the electrode active material and the solid electrolyte. Thereby, it is possible to prevent the formation of heterogeneous phases which are poor in ionic conductivity, and to inhibit an increase in internal resistance. Particularly in the case where the heating temperature is not less than 100° C. but not greater than 300° C., the increase in internal resistance can be avoided, and the water contained in the deliquescent solid electrolyte can be sufficiently excluded therefrom. This makes it possible to form the electrode layer with a higher capacity.

After the heat treatment, the electrode mixture is formed into the electrode layer. The thus-formed electrode layer may be shaped appropriately depending on the shape of the all-solid state battery. For example, the electrode layer may be shaped like a rectangular plate, a disk or the like. The forming step may be accomplished by pressing under a pressure which is not less than 5 Mpa but not greater than 200 Mpa. It is desirable that the pressure be selected in a range which does not allow the electrode mixture to be broken to avoid occurrence of grain boundaries. Incidentally, the electrode layer including the electrode mixture may be bonded to the current collector to produce the electrode for the all-solid state battery. In the case where the electrode layer including the electrode mixture is bonded to the current collector, the electrode for the all-solid state battery can be produced by applying the electrode mixture onto the current collector and thereafter heat-treating the electrode mixture, or by uniting the electrode layer and the current collector into one by thermal fusion bonding. The applying of the electrode mixture may be accomplished by using wet coating means such as a roll coater, a bar coater or a doctor blade.

In the bonding step, the electrodes produced as described above are paired and bonded together with the solid electrolyte layer interposed in between. In other words, in a case where the positive electrode layer is produced using the deliquescent solid electrolyte, the positive electrode layer is bonded to one surface of the solid electrolyte layer by pressure joining with the solid electrolyte layer interposed between the positive electrode layer and the negative electrode layer. Meanwhile, in a case where the negative electrode layer is produced using the deliquescent solid electrolyte, the negative electrode layer is bonded to one surface of the solid electrolyte layer by pressure joining with the solid electrolyte layer interposed between the negative electrode layer and the positive electrode layer. Otherwise, in a case where both the positive electrode layer and the negative electrode layer are produced using the deliquescent solid electrolyte, one surface of the solid electrolyte layer is bonded to the positive electrode layer by pressure joining, and the opposite surface of the solid electrolyte layer is bonded to the negative electrode layer by pressure joining, with the solid electrolyte layer interposed between the positive electrode layer and the negative electrode layer. An electrode assembly obtained by joining the electrode layers and the solid electrolyte layer is provided with output terminals connected thereto for outputting electric power from the all-solid state battery depending on the necessity. The output terminals, for example, may be made of aluminum or the like having resistance to voltage, and be welded to the current collector or the like. Thereafter, the resultant electrode assembly is enclosed in a casing shaped like a cylinder, a rectangle, a square, a coin, or a laminate, with insulating materials interposed between them, thereby giving the all-solid state battery.

The all-solid state battery produced as described above can be used as an all-solid state primary battery capable of irreversible discharging, or as an all-solid state secondary battery capable of reversible charging and discharging, by selecting the composition of the electrode layers and the composition of the active material depending on the necessity. The all-solid state secondary battery is particularly useful as the power source for household or industrial electric appliances, portable information communication apparatuses, power storage systems, ships, railway vehicles, aircrafts, hybrid vehicles, electric vehicles, and the like. Furthermore, the electrode layers and solid electrolyte layer of the all-solid state battery may be examined for their composition and structure by use of induction coupled plasma emission spectroscopic analysis, X-ray fluorescence analysis, or X-ray diffractometric analysis.

### EXAMPLES

Next, concrete descriptions will be provided for the present invention by showing examples. However, the technical scope of the present invention is not limited to these examples.

All-solid state batteries were produced each using lithium metavanadate as the deliquescent solid electrolyte, and were evaluated in terms of the internal resistance and discharge capacity.

### Example 1

As example 1, an all-solid state battery in which the content of the deliquescent solid electrolyte was 25 mass % per electrode was produced according to the following procedure.

This procedure started with weighing 1.85 g of lithium carbonate (Li₂CO₃) and 4.55 g of divanadium pentaoxide (V₂O₅), putting in a mortar, and homogeneously mixing. Thereafter, the thus-obtained mixture was transferred to an alumina-made crucible having 60 mm in outside diameter, and is heat-treated in a box-shaped electric furnace. Incidentally, this heat treatment was performed in the atmosphere in a way that: the temperature was raised to 580° C. at a rate of 10° C. per minute; and subsequently, this temperature was held for 10 hours. After this heat treatment, the mixture was cooled to 100° C. Thereby, lithium metavanadate (LiVO₃) was obtained.

Thereafter, weighing 1 mass % per dry weight of the electrode from the deliquescent solid electrolyte obtained as described above, and all of it was allowed to deliquesce in the air. After that, particles of LiCoO₂ as the positive electrode active material, and particles of a Li—Al—Ti—P-based oxide (LATP) in NASICON structure as the non-deliquescent solid electrolyte were added to the deliquescent solid electrolyte which had deliquesced, and were homogeneously mixed together to prepared the electrode mixture. The thus-obtained electrode mixture was applied onto a current collector of aluminum foil. This step was followed by heat treatment at 100° C. for 30 minutes to remove water. Thereafter, the electrode mixture on the current collector was punched into a disk with a cross-sectional area of 1 cm² to obtain a positive electrode.

Meanwhile, a negative electrode was produced by: press-bonding lithium foil and copper foil together; and punching the press-bonded lithium foil and copper foil into a disk with a cross-sectional area of 1 cm². In addition, 0.1 g of LATP was filled into a circular die of stainless steel having a cross-sectional area of 1 cm², and was formed into a solid electrolyte layer shaped like a disk by pressing under a pressure of 10 MPa in the circular die. The thus-obtained positive electrode, negative electrode and solid electrolyte layer were placed one over another with the solid electrolyte layer interposed between the positive electrode and the negative electrode. Subsequently, they were pressed under a pressure of 10 MPa for a minute to produce an electrode assembly. The two terminals of the electrode assembly on the positive electrode and negative electrode sides were held between separators of insulating material. After that, the resultant electrode assembly was enclosed in a casing of stainless steel, followed by being crimped with a torque of 15 N·m. Thus, an all-solid state battery of example 1 was obtained.

### Example 2

As example 2, an all-solid state battery was produced in which the content of the deliquescent solid electrolyte was 5 mass % per electrode. Incidentally, the all-solid state battery of example 2 was produced according to the same procedure as was the all-solid state battery of example 1, except that the weight of the deliquescent solid electrolyte to be used to produce the electrode was different between example 1 and example 2.

### Example 3

As example 3, an all-solid state battery was produced in which the content of the deliquescent solid electrolyte was 25 mass % per electrode. Incidentally, the all-solid state battery of example 3 was produced according to the same procedure as was the all-solid state battery of example 1, except that the weight of the deliquescent solid electrolyte to be used to produce the electrode was different between example 1 and example 3.

### Example 4

As example 4, an all-solid state battery was produced in which the content of the deliquescent solid electrolyte was 50 mass % per electrode. Incidentally, the all-solid state battery of example 4 was produced according to the same procedure as was the all-solid state battery of example 1, except that the weight of the deliquescent solid electrolyte to be used to produce the electrode was different between example 1 and example 4.

### Example 5

As example 5, an all-solid state battery was produced in which the content of the deliquescent solid electrolyte was 60 mass % per electrode. Incidentally, the all-solid state battery of example 5 was produced according to the same procedure as was the all-solid state battery of example 1, except that the weight of the deliquescent solid electrolyte to be used to produce the electrode was different between example 1 and example 5.

### Comparative Example 1

As comparative example 1, an all-solid state battery was produced for whose electrodes with no deliquescent solid electrolyte was used. Incidentally, the all-solid state battery of comparative example 1 was produced according to the same procedure as was the all-solid state battery of example 1, except that the electrode mixture for the positive electrode was prepared by homogeneously mixing LiCoO₂ as the positive electrode active material and the Li—Al—Ti—P-based oxide (LATP) in NASICON structure as the non-deliquescent solid electrolyte.

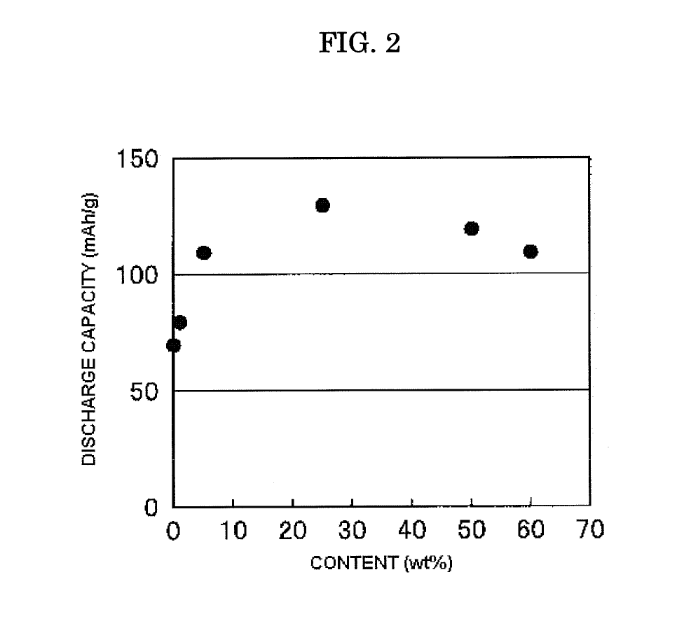

Thereafter, the produced all-solid state batteries of examples 1 to 5 and comparative example were measured in terms of discharge capacity and DC internal resistance. Incidentally, the measurement was carried out at an ambient temperature of 20° C. The discharge capacity of each all-solid state battery was measured by: at first, charging the all-solid state battery up to the final voltage of 4.2 V with constant current and constant voltage; subsequently leaving the all-solid state battery for a while; and thereafter discharging the all-solid state battery down to the final voltage of 2.5 V with a constant current of 0.2 lₜA. The result of the measurement is shown in Table 1 and FIG. 2. On the other hand, a discharge voltage of each all-solid state battery was measured after: at first, charging the all-solid state battery up to the final voltage of 4.2 V with constant current and constant voltage; subsequently leaving the all-solid state battery for a while; thereafter discharging the all-solid state battery down to 50% of the capacity with a constant current of 0.2 lₜA; and subsequently discharging the all-solid state battery with a constant current of 0.2 lₜA for 30 seconds. Afterward, another discharge voltage of each all-solid state battery was measured after discharging the all-solid state battery for 5 seconds with a discharge current of 1.0 lₜA instead of the previously-used constant current of 0.2 lₜA. Eventually, the DC internal resistance of each all-solid state battery was calculated by dividing the difference between the thus-measured discharge voltages by the difference between the discharge currents measured as described above. The result of the calculation is shown in Table 1.

TABLE 1

| | content of | | |
|---|---|---|---|
| | deliquescent | discharge | DC internal |
| | solid electrolyte | capacity | resistance |
| | (wt %) | (mAh/g) | (kΩ · cm²) |
| Example 1 | 1 | 80 | 2.2 |
| Example 2 | 5 | 110 | 2.0 |
| Example 3 | 25 | 130 | 1.3 |
| Example 4 | 50 | 120 | 3.0 |
| Example 5 | 60 | 110 | 5.0 |
| Comparative | 0 | 70 | 25 |
| Example 1 | | | |

FIG. 2 is a diagram showing a relationship between the content of the deliquescent solid electrolyte in each all-solid state battery of the embodiment and its discharge capacity.

In FIG. 2, the horizontal axis represents the content (mass %) of lithium metavanadate (LiVO₃) used as the deliquescent solid electrolyte per electrode, while the vertical axis represents the discharge capacity (mAh/g) of each of the produced all-solid state batteries of examples 1 to 5 and comparative example.

As shown in Table 1 and FIG. 2, it was proved that the all-solid state batteries of examples 1 to 5 became better in terms of the discharge capacity than the all-solid state battery of comparative example 1. High discharge capacity above 100 mAh/g was obtained particularly from the all-solid state batteries of examples 2 to 5 in which the content of the deliquescent solid electrolyte was 5 mass % or greater. It was proved that the all-solid state batteries of examples 2 to 5 sufficiently met the generally-required output performance. Incidentally, one may consider that the reason why the discharge capacity of the all-solid state battery of example 1 was lower than the all-solid state batteries of the other examples was that the smaller content of the deliquescent solid electrolyte was insufficient to enhance the quality of contact between the active material and the deliquescent solid electrolyte, as well as between the active material and the non-deliquescent solid electrolyte.

In addition, as learned from the comparison between examples 1 to 5 and comparative example 1, it was proved that the use of the deliquescent solid electrolyte reduced the DC internal resistance. As shown by examples 1 to 3 in particular, it was proved that as the content of the deliquescent solid electrolyte became larger, the DC internal resistance became smaller. However, as shown by examples 4 and 5, the DC internal resistance tended to increase when the content of the deliquescent solid electrolyte was about to exceed 50 mass % to 60 mass %. One may consider that the reason why the DC internal resistance increased according to the increase in the content of the deliquescent solid electrolyte was that the deliquescent solid electrolyte is poorer in the ionic conductivity than the non-deliquescent solid electrolyte used therein. In other words, it may be considered that an excessive amount of deliquescent solid electrolyte included therein made the ionic conductivity in the electrode layer become lower, or that an excessive thickness of the deliquescent solid electrolyte in the electrode layer made the ionic conductivity in the electrode layer become lower.

Furthermore, as learned from FIG. 2, the tendency for the all-solid state batteries of examples 1 to 5 to enhance the discharge capacity is characterized by a plot pattern which is shaped like an arc corresponding to the increase in the content of the deliquescent solid electrolyte. It was proved that while the content of the deliquescent solid electrolyte was in a range not less than 5 mass % but not greater than 50 mass %, a high capacity equivalent to the effective capacity of LiCoO₂ was achieved. In sum, it was proved that the content of the deliquescent solid electrolyte which is not less than 5 mass % but not greater than 50 mass % is preferable to manufacture all-solid state batteries with a lower internal resistance and a higher discharge capacity.

### REFERENCE SIGNS LIST

1: all-solid state battery
2A: positive electrode layer
2B: negative electrode layer
2C: solid electrolyte layer
10A: positive electrode active material (active material)
10B: negative electrode active material (active material)
20: deliquescent solid electrolyte
30: solid electrolyte

1. An all-solid state battery comprising:
a pair of electrodes including a positive electrode and a negative electrode; and
a solid electrolyte layer interposed between the positive electrode and the negative electrode, wherein
at least one of the positive electrode and the negative electrode includes an electrode layer including
a deliquescent solid electrolyte providing ionic conductivity, electronic conductivity and a deliquescent property, and
particles of an active material, and
the deliquescent solid electrolyte is an alkali metal metavanadate.

2. The all-solid state battery according to claim 1, wherein the electrode layer is formed by filling the deliquescent solid electrolyte among the particles of the active material.

3. The all-solid state battery according to claim 1, wherein the at least one of the positive electrode layer and the negative electrode layer further includes a non-deliquescent solid electrolyte having ionic conductivity.

4. The all-solid state battery according to claim 3, wherein a content of the deliquescent solid electrolyte is not less than 5 mass % but not greater than 50 mass % of a total dry weight of the deliquescent solid electrolyte, the non-deliquescent solid electrolyte and the active material per electrode.

5. (canceled)

6. The all-solid state battery according to claim 1, wherein the deliquescent solid electrolyte is lithium metavanadate.

7. An electrode for an all-solid state battery, comprising:
a current collector; and
an electrode layer formed on the current collector, and including
a deliquescent solid electrolyte having ionic conductivity, electronic conductivity and a deliquescent property, and
particles of an active material, wherein
the electrode layer is formed by filling the deliquescent solid electrolyte among the particles of the active material, and
the deliquescent solid electrolyte is an alkali metal metavanadate.

8. The electrode for an all-solid state battery according to claim 7, wherein the electrode layer further includes a non-deliquescent solid electrolyte which is conductive to ions.

9. The electrode for an all-solid state battery according to claim 8, wherein a content of the deliquescent solid electrolyte is not less than 5 mass % but not greater than 50 mass % of a total dry weight of the deliquescent solid electrolyte, the non-deliquescent solid electrolyte and the active material per electrode.

10. The electrode for an all-solid state battery according to claim 7, wherein the deliquescent solid electrolyte is lithium metavanadate.

11. A method of manufacturing an all-solid state battery, comprising the steps of:
causing a deliquescent solid electrolyte to deliquesce, the deliquescent solid electrolyte having ionic conductivity, electronic conductivity and a deliquescent property;
preparing an electrode mixture by mixing the deliquescent solid electrolyte having deliquesced and an active material together;
heat-treating and shaping the electrode mixture to produce an electrode; and
bonding the thus-produced electrode and a solid electrolyte layer with the solid electrolyte layer interposed between the electrode and another electrode which are paired to serve as a positive electrode and a negative electrode.

12. The method of manufacturing an all-solid state battery according to claim 11, wherein in the electrode mixture preparing step, a non-deliquescent solid electrolyte which is conductive to ions is additionally mixed together with the deliquescent solid electrolyte and the active material.

13. The method of manufacturing an all-solid state battery according to claim 11, wherein a dry weight of the deliquescent solid electrolyte mixed therewith is not less than 5 parts by mass but less than 50 parts by mass of a total dry weight of the deliquescent solid electrolyte, the non-deliquescent solid electrolyte and the active material.

14. The method of manufacturing an all-solid state battery according to claim 11, wherein a heating temperature for the heat treatment is not less than 100° C. but not greater than 300° C.

15. The method of manufacturing an all-solid state battery according to claim 11, wherein the deliquescent solid electrolyte is an alkali metal metavanadate.
